(19) United States
(12) Patent Application Publication
(10) Pub. No.: US 2026/0320066 A1
(43) Pub. Date: Oct. 15, 2026

(54) METHODS FOR GENERATING AN INTERACTIVE ROADMAP USING DATABASES AND ARTIFICIAL INTELLIGENCE

(71) Applicant: Jones Lang LaSalle IP, Inc., Chicago, IL (US)

(72) Inventors: Gaston BLONDEAU LEÓN, Madrid (ES); Pedro RODRIGUEZ, Madrid (ES); Sergio MARTIN, Madrid (ES); Alberto MELERO, Madrid (ES)

(21) Appl. No.: 19/178,445

(22) Filed: Apr. 14, 2025

(51) Int. Cl. G06F 16/25; G06F 16/28; G06Q 50/16

(52) U.S. Cl. CPC G06F 16/254; G06F 16/284; G06Q 50/16

(57) ABSTRACT

A method, system, and non-transitory computer readable medium can include storing real estate data from a plurality of platforms into a relational data structure. The method can further involve generating at least one node and at least one edge using an ETL process and the relational data structure, wherein the ETL process can utilize data bricks and a data factory to transform the real estate data from the relational data structure into the at least one node and the at least one edge. Subsequently, the method can include providing an interactive map comprising a visualization of relationships between the at least one node and the at least one edge.

### FIELD

This technology generally relates to generating intelligent interactive maps and, more particularly, to methods for providing an interactive map of relationships between properties and stakeholders linked to relevant systems.

### BACKGROUND

Traditional systems for managing property and stakeholder data are fraught with inefficiencies and complexities that hinder overall productivity. These systems often require users to navigate multiple platforms to find relevant data, which is both time-consuming and prone to errors. Additionally, understanding the relationships between properties and stakeholders remains a significant challenge. Traditional systems do not effectively support the visualization of these relationships, making it difficult to interpret the connections and dependencies between various data points. This lack of transparency complicates the process of making informed business decisions, especially when data is fragmented across numerous platforms.

For example, a real estate company may have data on properties, stakeholders, clients, and transactions spread across multiple applications, such as Capforce, Horizon, and PIX. It is unclear which application provides the most relevant and complete data, leading to inefficiencies and missed opportunities. Users must sift through large volumes of data and documentation to find relevant information, which can be a daunting and overwhelming task. The lack of a standardized and streamlined approach to data integration and visualization further exacerbates these challenges, making it difficult to conduct thorough and efficient data analysis. Consequently, there is a clear need for improved systems that can streamline the data integration and visualization processes, enhance data utilization, and support the identification of business opportunities.

### SUMMARY

A method that can store real estate data from a plurality of platforms into a relational data structure includes generating at least one node and at least one edge using an ETL process and the relational data structure. The ETL process can utilize data bricks and a data factory to transform the real estate data from the relational data structure into the at least one node and the at least one edge. Subsequently, the method can include providing an interactive map comprising a visualization of relationships between the at least one node and the at least one edge.

A non-transitory computer readable medium having stored thereon instructions comprising machine executable code which when executed by at least one processor, causes the processor to store real estate data from a plurality of platforms into a relational data structure. The executable code, when executed by at least one processor, can further cause the processor to generate at least one node and at least one edge using an ETL process and the relational data structure. The ETL process can utilize data bricks and a data factory to transform the real estate data from the relational data structure into the at least one node and the at least one edge. Furthermore, the executable code can cause the processor to provide an interactive map comprising a visualization of relationships between the at least one node and the at least one edge.

A computing apparatus including at least one of configurable hardware logic configured to be capable of implementing or a processor coupled to a memory and configured to execute programmed instructions stored in the memory to store real estate data from a plurality of platforms into a relational data structure. The programmed instructions, when executed by at least one processor, can further cause the processor to generate at least one node and at least one edge using an ETL process and the relational data structure. The ETL process can utilize data bricks and a data factory to transform the real estate data from the relational data structure into the at least one node and the at least one edge. Furthermore, the programmed instructions can cause the processor to provide an interactive map comprising a visualization of relationships between the at least one node and the at least one edge.

A network traffic management system including at least memory comprising programmed instructions and one or more processors configured to store real estate data from a plurality of platforms into a relational data structure. The programmed instructions, when executed by at least one processor, can further cause the processor to generate at least one node and at least one edge using an ETL process and the relational data structure. The ETL process can utilize data bricks and a data factory to transform the real estate data from the relational data structure into the at least one node and the at least one edge. Furthermore, the programmed instructions can cause the processor to provide an interactive map comprising a visualization of relationships between the at least one node and the at least one edge.

This invention provides a number of advantages, including offering a method, non-transitory computer-readable medium, and apparatus that enable the generation an intelligent interactive map that visualizes relationships between properties and their stakeholders. By integrating data from various platforms into a centralized, user-friendly interface, the system ensures efficient data navigation and utilization. This significantly reduces the time and effort required to locate relevant data, thereby enhancing the overall efficiency and effectiveness of business operations.

Additionally, the system also facilitates the identification of potential business opportunities through the visualization of relationships. By providing tools for improved data transparency, users can understand the connections and dependencies between various data points. This transparency aids in uncovering cross-selling opportunities and optimizing costs by identifying data redundancies across systems. The system's ability to dynamically generate and refine visual representations of relationships further enhances its utility, making it easier for users to conduct thorough and efficient data analysis.

Overall, this invention addresses inefficiencies in data integration and visualization by providing a comprehensive interactive map. It improves the efficiency of business operations by reducing the cognitive load on users and enabling faster, more accurate decision-making. The disclosed technology leverages advanced techniques such as the conversion of relational data into a graph data model, the use of AI models to predict potential connections and business opportunities, and the implementation of natural language processing to facilitate data integration. These features collectively enhance the system's ability to provide a collaborative environment for visualizing relationships, generating connections, and identifying business opportunities, offering significant improvements over conventional systems.

### BRIEF DESCRIPTION OF THE DRAWINGS

FIG. 1 is a block diagram of an example of an environment with a relational computing system;

FIG. 2A is a block diagram illustrating an example of an architecture of a relational computing system;

FIG. 2B is a block diagram illustrating an example of an architecture of a database;

FIG. 2C is a block diagram illustrating an example of an architecture of a client device;

FIG. 3 is an exemplary flowchart of an exemplary method of generating intelligent interactive maps;

FIG. 4 is an exemplary interface of a process by the relational computing system;

FIG. 5 is an exemplary interface of an interactive map focused on a property address by the relational computing system;

FIG. 6 is an exemplary interface of the property address by the relational computing system;

FIG. 7 is an exemplary interface of an interactive map focused on a company by the relational computing system; and

FIG. 8 is an exemplary flow of a process by the relational computing system.

### DETAILED DESCRIPTION

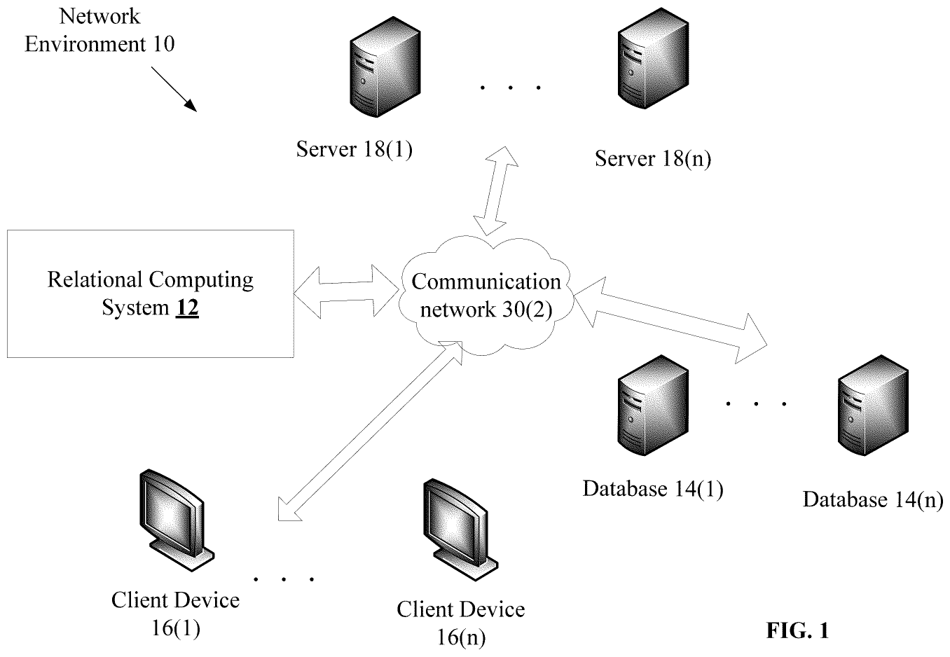

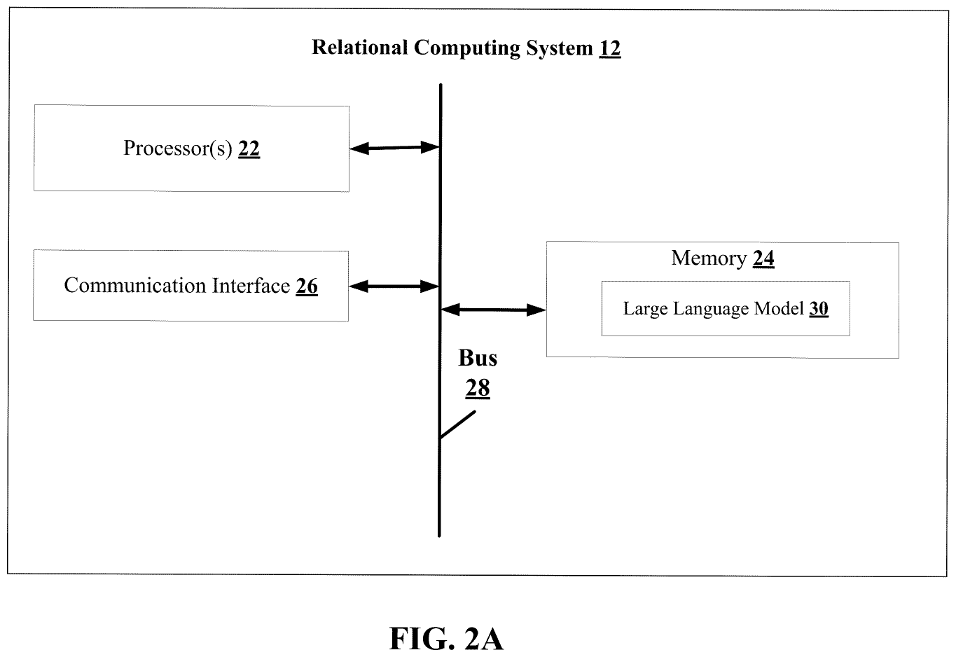

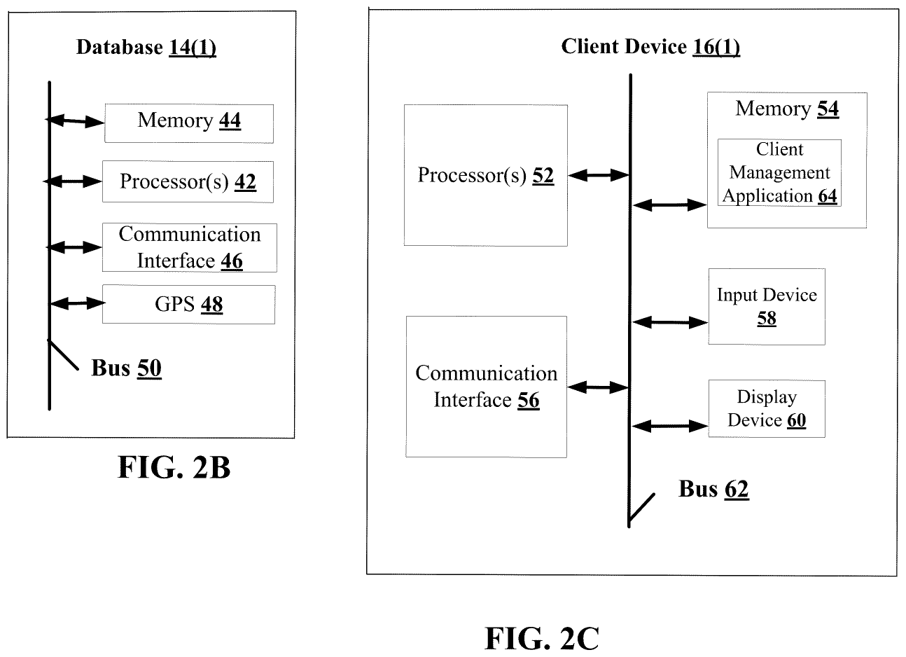

An environment 10 with an exemplary relational computing system 12 is shown in FIGS. 1-2A. In this example, the environment 10 includes the relational computing system 12, a plurality of databases 14(1)-14(n), a plurality of client devices 16(1)-16(n), and a plurality of servers 18(1)-18(n), although the environment may comprise other types and/or numbers of other systems, devices, components, and/or other elements in other configurations. This technology provides a number of advantages including providing systems, methods, and non-transitory computer readable media that enable the dynamic generation of an interactive map using relational databases.

Referring to more specifically to FIGS. 1-2A, in this example, the relational computing system 12 includes one or more processor(s) 22, a memory 24, and/or a communication interface 26, which are coupled together by a bus or other communication link 28, although the relational computing system 12 can include other types and/or numbers of elements in other configurations.

The processor(s) 22 of the relational computing system 12 may execute programmed instructions stored in the memory of the relational computing system 12 for any number of functions and other operations as illustrated and described by way of the examples herein. The processor(s) 22 of the relational computing system 12 may include one or more CPUs or general purpose processors with one or more processing cores, for example, although other types of processor(s) can also be used.

The memory 24 of the relational computing system 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s), can be used for the memory 24.

Accordingly, the memory 24 of the relational computing system 12 can store one or more applications that can include computer executable instructions that, when executed by the relational computing system 12, cause the relational computing system 12 to perform actions, such as generate an interactive map based on user queries and relational databases, and other actions as described and illustrated in the examples below with reference to FIGS. 1-8. The application(s) can be implemented as modules, programmed instructions, or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the relational computing system 12 itself, may be located in virtual server(s) running in a cloud-based computing environment rather than being tied to one or more specific physical computing devices. Also, the application(s) may be running in one or more virtual machines (VMs) executing on the relational computing system 12. Additionally, in one or more embodiments of this technology, virtual machine(s) running on the relational computing system 12 may be managed or supervised by a hypervisor.

In this particular example, the memory 24 of the relational computing system 12 may include a large language model 30 which may be executed as illustrated and described by way of the examples herein, although the memory 24 can for example include other types and/or numbers of modules, platforms, algorithms, programmed instructions, applications, or databases for implementing examples of this technology.

The machine learning model 30 may be a large language model (LLM) 30. The LLM 30 can be configured to perform a wide range of natural language processing tasks, including engaging in conversational dialogue. Although not illustrated, the plurality of servers 18(1)-18(n) may host and/or manage a plurality of LLMs which may be pre-trained general purpose LLMs or fine-tuned LLMs. The plurality of servers 18(1)-18(n) may be a cloud-based server or an on-premises server. The fine-tuned LLM 30 may be accessed using an application programming interface (API) for use in applications. In another example, the fine-tuned LLM 30 may be hosted by the plurality of servers 18(1)-18(n) and managed remotely by the relational computing system 12.

An LLM 30 is a type of artificial intelligence-machine learning (AI/ML) model that is used to process natural language data for tasks such as natural language processing, text mining, text classification, machine translation, question-answering, response generation, or the like. The LLM 30 uses deep learning or neural networks to learn language features from large amounts of data. The LLM 30 is, for example, trained on a dataset and then used to analyze data, generate predictions and code, project strings into a semantic vector space, or generate features from unseen data. The LLM 30 can be used to generate language features such as word embeddings, part-of-speech tags, named entity recognition, sentiment analysis, or the like. Unlike traditional rule-based NLP systems, the LLM 30 does not rely on pre-defined rules or templates to process responses.

The relational computing system 12 can leverage natural language processing for query translation, allowing users to input queries in human language. For example, the relational computing system 12 can translate these queries into machine language to retrieve relevant data and integrate it into the interactive map accordingly. This feature can make the relational computing system 12 highly user-friendly and accessible to non-technical users, enabling them to explore complex data relationships effortlessly.

The relational computing system 12 may contain programs that train, implement, store, receive, retrieve, and/or transmit one or more machine learning models 30. Machine learning models 30 may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, graph neural networks (GNN), and/or another machine learning model. Models 30 may include an ensemble model (e.g., a model comprised of a plurality of models). In some embodiments, training of a model 30 may terminate when a training criterion is satisfied. Training criterion may include a number of epochs, a training time, a performance metric (e.g., an estimate of accuracy in reproducing test data), or the like. The relational computing system 12 may be configured to adjust model parameters during training.

Model 30 parameters may include weights, coefficients, offsets, or the like. Training may be supervised or unsupervised.

The relational computing system 12 may be configured to train machine learning models 30 by optimizing model parameters and/or hyperparameters (hyperparameter tuning) using an optimization technique, consistent with disclosed embodiments. Hyperparameters may include training hyperparameters, which may affect how training of the model 30 occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The relational computing system 12 may be configured to optimize statistical models 30 using known optimization techniques.

The relational computing system 12 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the relational computing system 12 may analyze information applying machine-learning methods.

In a non-limiting example, the machine learning model 30 can be Graph Neural Networks (GNN) configured to analyze or predict relationships between various data points. GNNs work by propagating information across the nodes and edges of a graph, allowing the model to learn representations of the nodes based on their connections and features. They iteratively update the node representations by aggregating information from their neighbors, capturing the complex dependencies and interactions within the graph. This process enables GNNs to effectively analyze and understand the structure and relationships within the data. GNN models can be used to predict potential connections and business opportunities by identifying patterns and structures within graph data. This capability can enhance the relational computing system 12′s ability to uncover hidden relationships and generate insights that are not immediately apparent through traditional analysis methods.

The communication interface 26 of the relational computing system 12 operatively couples and communicates between the relational computing system 12 and the one or more of databases 14(1)-14(n), the one or more of the client devices 16(1)-16(n), and the one or more servers 18(1)-18(n), although other types and/or numbers of connections and/or communication networks can be used.

While the relational computing system 12 is illustrated in this example as including a single device, the relational computing system 12 in other examples can include a plurality of devices each having one or more processors (each processor with one or more processing cores) that implement one or more steps of this technology. In these examples, one or more of the devices can have a dedicated communication interface or memory. Alternatively, one or more of the devices can utilize the memory, communication interface, or other hardware or software components of one or more other devices included in the relational computing system 12.

Additionally, one or more of the devices that together comprise the relational computing system 12 in other examples can be standalone devices or integrated with one or more other devices or apparatuses, such as in one of the server devices or in one or more computing devices for example. Moreover, one or more of the devices of the relational computing system 12 in these examples can be in a same or a different communication network including one or more public, private, or cloud networks, for example.

Although an exemplary relational computing system 12 is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the components depicted in this relational computing system 12 may be configured to operate as virtual instances on the same physical machine. In other words, by way of example one or more of the relational computing system 12 may operate on the same physical device rather than as separate devices communicating through communication network(s). Additionally, there may be more or fewer relational computing system 12 than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to conduct steps necessary to implement the methods of the examples of this technology that are described and illustrated herein.

Referring to FIGS. 1 and 2B, the plurality of databases 14(1)-14(n) may comprise a variety of different types and/or numbers of systems, devices, or other things in the environment 10, such as a variety of different text data or other data or combinations thereof by way of example only. In this example, each of the databases 14(1)-14(n) at least have the same following structure and operation as shown in the example of the database 14(1) shown in FIG. 2B, although databases 14(1)-14(n) with other types and/or numbers of other systems, devices, components, and/or other elements may be used. Additionally, in this example, the database 14(1) has one or more processors 42, a memory 44, a communication interface, and a global positioning system (GPS) device 48 which are coupled together by a bus or other communication link 50, although each database of data could have other types and/or numbers of systems, devices, components and/or other elements in other configurations.

The plurality of databases 14(1)-14n) can be relational databases, designed to recognize relationships among stored items of information. Relational databases can use structured query language (SQL) for defining and manipulating data, making it easy to manage and query large amounts of structured data. These databases can be highly efficient for operations that require the joining of tables and the execution of complex queries.

In a non-limiting example, the plurality of databases 14(1)-14(n) can be Azure Cosmos DB databases. Azure Cosmos DB databases with relational capabilities can be a type of globally distributed, multi-model database service provided by Microsoft. Azure Cosmos DB can support multiple data models, including document, key-value, graph, and column-family, and it can offer native support for NoSQL. With relational capabilities, Azure Cosmos DB can handle complex queries and transactions, providing the flexibility to work with both structured and unstructured data. This can make it an ideal choice for applications that require high availability, low latency, and scalability. These capabilities can be leveraged within the plurality of databases 14(1)-14(n) to ensure robust and flexible data management.

The plurality of databases 14(1)-14(n) can hold nodes and edges representing properties, companies, stakeholders, and their relationships. Nodes can represent entities such as properties, companies, and stakeholders, while edges can represent the relationships between these entities. This graph-based data structure can allow for the efficient representation and querying of complex relationships within the data.

The plurality of databases 14(1)-14(n) can support different visualizations using a JavaScript library for graph visualization. Libraries such as D3.js or Cytoscape.js can be used to create interactive and dynamic visualizations of the graph data. These visualizations can help users to explore and understand the relationships between different entities, making it easier to identify patterns, trends, and insights. By providing a visual representation of the data, users can gain a deeper understanding of the underlying relationships and make more informed decisions.

Referring to FIGS. 1 and 2C, the plurality of client devices 16(1)-16(n) in this example includes any type of computing device that can participate in the generating of code in an environment 10 with a client management application 64, such as mobile computing devices, desktop computing devices, laptop computing devices, tablet computing devices, virtual machines (including cloud-based computers), or the like. In this example, each of the client devices 16(1)-16(n) at least have the same following structure and operation as shown in the example of the client device 16(1) shown in FIG. 2C, although client devices with other types and/or numbers of other systems, devices, components, and/or other elements may be used. Additionally in this example, the client device 16(1) includes one or more processor 52, a memory 54, a communication interface 56, an input device 58, and a display device 60, which are coupled together by a bus or other communication link 62, types and/or numbers of systems, devices, components, or other elements in other configurations. Additionally, in this example the memory 34 includes a client management application 64 which enables the client 16(1) to interact with the relational computing system 12 and one or more of the databases 14(1)-14(n) as illustrated and described by way of the examples herein, although the memory 54 can include other programmed instructions, modules, applications, or other data for example.

The plurality of servers 18(1)-18(n) in this example includes one or more processors, a memory, and a communication interface, which are coupled together by a bus or other communication link, although other numbers and/or types of network devices could be used. In this example, the servers 18(1)-18(n) can be located at different locations and may each process requests received from the relational computing system 12 and/or the client devices 16(1)-16(n) via the communication network(s) 20. Various data and other applications may be operating on the relational computing system 12 and transmitting data (e.g., files or Web pages) to the relational computing system 12 and/or the client devices 16(1)-16(n). The servers 18(1)-18(n) may be hardware or software or may represent a system with multiple servers in a pool, which may include internal or external networks.

An exemplary method for dynamically refining analysis using the LLM 30 in the environment 10 with the relational computing system 12 will now be described with reference to FIGS. 1-8.

### Generating Interactive Maps

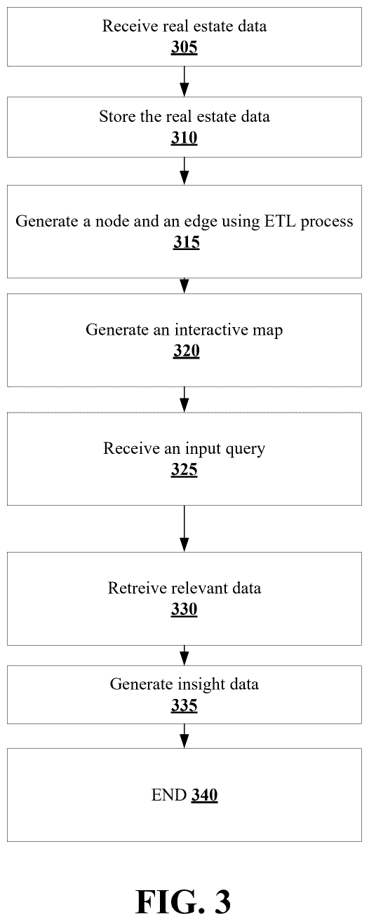

Turning to FIG. 3, in step 305, the relational computing system 12 can retrieve real estate data from a plurality of platforms at one of the plurality of servers 18(1)-(n). The real estate data can include at least one of properties, companies, stakeholders, relationships, transactions, leases, other real estate factors known in the art, or combinations thereof. The relational computing system 12 can retrieve the real estate data by establishing secure connections to various data sources at one of the plurality of servers 18(1)-(n), such as SQL databases, NoSQL databases, cloud storage services, and APIs provided by real estate platforms. The relational computing system 12 can establish secure connections using industry-standard encryption protocols, such as TLS (Transport Layer Security) or SSL (Secure Sockets Layer), to ensure data integrity and confidentiality during transmission. These platforms can include property listing services, client relationship management (CRM) systems, financial transaction databases, public records repositories, or combinations thereof.

In step 310, the relational computing system 12 can store the real estate data from the plurality of platforms into a relational data structure. Using relational data structures can be beneficial because they can provide a structured and efficient way to organize and query data, ensuring data integrity, reducing redundancy, and enabling complex queries through SQL (Structured Query Language). The relational data structure can be an instance of Azure Cosmos DB, MySQL, PostgreSQL, Microsoft SQL Server, or other relational data structures known in the art. Azure Cosmos DB has relational capabilities through its support for multiple data models, including the SQL API, Gremlin API, Table API, or other APIs known in the art, which allows for relational data modeling and querying. This can enable the relational computing system 12 to leverage the scalability and global distribution features of Azure Cosmos DB while maintaining the benefits of a relational database structure. Additionally, Azure Cosmos DB supports ACID transactions, indexing, and rich querying capabilities, making it a versatile choice for storing and managing relational data.

### Node and Edge Generation

In step 315, the relational computing system 12 can generate at least one node and at least one edge using an ETL process and the relational data structure. An ETL (Extract, Transform, Load) process is a data pipeline used to collect data from various sources, transform the data according to rules, and load the data into a target data store. In a non-limiting example, the ETL process can include data bricks and a data factory to migrate and transform the real estate data from the relational data structure into the at least one node and the at least one edge. The at least one node can represent the properties, companies, stakeholders, transactions, leases, or other real estate factors in the real estate data. The at least one edge can represent the relationships between the nodes, such as ownership, tenancy, business transactions, or any other relevant connections that link the entities represented by the nodes.

### Data Bricks

Data bricks are a unified analytics platform designed to simplify and accelerate data engineering, data science, and machine learning tasks. Data bricks can achieve this by leveraging distributed computing frameworks such as Apache Spark. By distributing data processing tasks across multiple nodes in a cluster, data bricks can handle large-scale data transformations and computations in parallel, significantly reducing processing time. An example of a data brick is Databricks, which integrates with Apache Spark to provide a powerful data processing environment. Databricks allows users to create and manage Spark clusters, execute Spark jobs, and utilize a collaborative notebook interface for interactive data analysis and visualization. The ETL process is closely related to data bricks as it leverages the data processing capabilities of platforms like Databricks to perform the transformation and loading steps. During the ETL process, data bricks can be used to extract data from various sources, apply complex transformations and data cleaning operations, and then load the transformed data into the target data store.

### Data Factories

A data factory is a cloud-based data integration service that allows you to create, schedule, and orchestrate data pipelines. It can enable the movement and transformation of data across various data stores and services. An example of a data factory is Azure Data Factory, which provides a comprehensive platform for building, managing, and automating data workflows. Azure Data Factory can play a crucial role in the ETL process by orchestrating the data movement and transformation activities. It can connect to various data sources, extract the required data, and then use data bricks or other transformation tools to process the data. Once the data is transformed, Azure Data Factory can load it into the target data store, ensuring that the entire ETL process is automated, scalable, and efficient.

### ETL Process

In a non-limiting example, the relational computing system 12 can implement the ETL process by: (1) extracting the real estate data from the relational data structure using the data factory and a data lake storage; (2) transforming, using the data bricks, the extracted real estate data into the at least one node and the at least one edge; and (3) load the at least one node and the at least one edge into a database.

### A. Extract

The relational computing system 12 can extract the real estate data from the relational data structure using the data factory and the data lake storage by generating a connection between the relational data structure and the data lake storage. The relational computing system 12 can then define datasets in the data factory for the relational data structure and the data lake storage.

A data lake storage is a centralized repository that allows the storage of all structured and unstructured data at any scale. Data lake storage enables the storage of data in its native format until it is needed for analytics. Data lake storage can handle vast amounts of data and supports various data formats, making data lake storage an ideal solution for big data analytics. Data lake storage can be stored on servers at one of the plurality of servers 18(1)-(n) or external databases at one of the plurality of databases 14(1)-(n), depending on the specific implementation and requirements of the organization.

The relational computing system 12 can generate a connection between the relational data structure and the data lake storage by using secure network protocols and data integration tools. For example, the relational computing system 12 can use Azure Data Factory to create linked services that define the connection information for both the relational data structure and the data lake storage. Linked services in Azure Data Factory are connections to data stores or compute services that define the connection information needed for the data factory to access the data. Linked services are created by specifying the connection strings, authentication methods, and any necessary configurations to establish a secure and reliable connection between the two data stores (i.e., the relational data structure and the data lake storage).

Establishing this connection can assist for the next step of defining datasets because by having a secure and reliable connection between the relational data structure and the data lake storage, the relational computing system 12 can ensure that the real estate data can be seamlessly transferred and accessed between these two data stores. This connection allows the relational computing system 12 to define datasets in the data factory that accurately represent the data structures within both the relational data structure and the data lake storage. Datasets in a data factory represent the data structures within the data stores (i.e., the relational data structure and the data lake storage) that are used in the ETL process. Datasets define the schema and location of the data to be processed. In Azure Data Factory, for example, datasets can be defined by specifying the data source type, the path to the data, and the schema of the data. This allows the data factory to understand the structure and format of the data it will be working with.

### B. Transform

The relational computing system 12 can then transform the extracted real estate data in the data lake storage into the at least one node and the at least one edge using the data bricks. The relational computing system 12 can achieve this transformation through several technical steps. First, the relational computing system 12 can use data bricks to extract the real estate data from the data lake storage and load the real estate data into a distributed data processing environment. This can involve reading the real estate data from the defined datasets and loading it into data frames. Data frames are in-memory data structures used for data manipulation and analysis. Next, the relational computing system 12 can perform data cleaning and preprocessing tasks using data bricks, such as removing duplicates, handling missing values, and standardizing data formats to ensure consistency and accuracy. Data bricks can leverage Apache Spark's built-in functions for these tasks, enabling efficient processing of large datasets.

The relational computing system 12 can then identify and segment the real estate data into distinct entities. The relational computing system 12 can identify the entities by analyzing data fields in the real estate data and applying predefined rules or machine learning algorithms to classify the real estate data into specific entity types. For example, the relational computing system 12 can use pattern recognition techniques to identify property addresses, company names, stakeholder information, transaction details, lease agreements, or other data fields in the real estate data. The relational computing system 12 can generate the at least one node by loading the real estate data into separate data frames for each entity type based on the recognized patterns. The entities of the real estate data can include at least one of properties, stakeholders, companies, transactions, leases, other entities known in the art, or combinations thereof. For each entity type, the relational computing system 12 can create nodes by mapping the relevant data fields to node attributes. For example, property nodes can include attributes such as property ID, address, and property type, other property attributes known in the art, while company nodes can include attributes such as company ID, name, industry, and other company attributes known in the art.

Subsequently, the relational computing system 12 can then generate (or define) edges by identifying relationships between the nodes (or the entities of the real estate data). This can involve analyzing the real estate data to determine connections, such as ownership, tenancy, business transactions, other relationships known in the art, or combinations thereof. The relational computing system 12 can then create edges by mapping these relationships to edge attributes, such as edge type, relationship strength, or other edge attributes known in the art.

### C. Load

In a non-limiting example, the relational computing system 12 can then load the at least one node and the at least one edge into a graph database or another suitable data store. The other suitable data store can be a node and edge database at one of the databases 14(1)-(n). The graph database can also be at one of the databases 14(1)-(n). The relational computing system 12 can also use data bricks to transform the data frames into the graph database. The relational computing system 12 can achieve this transformation by leveraging the distributed computing capabilities of data bricks, specifically using Apache Spark's GraphX or GraphFrames libraries. These libraries provide APIs for creating and manipulating graphs and performing graph-parallel computations. The relational computing system 12 can first convert the data frames containing nodes and edges into a format compatible with the graph processing libraries. This involves defining vertex and edge DataFrames, where each vertex DataFrame represents the nodes and each edge DataFrame represents the relationships between the nodes. The relational computing system 12 can then use the GraphX or GraphFrames APIs to create a graph object from these DataFrames. This graph object can be used to perform various graph operations and analyses, such as traversals, shortest path calculations, and community detection.

### Interactive Map Generation

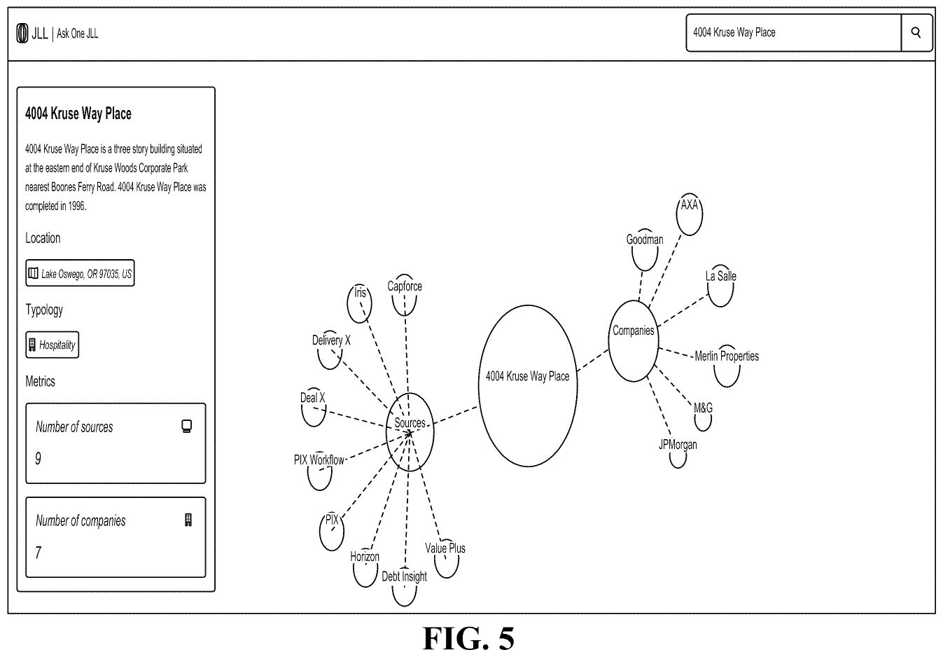

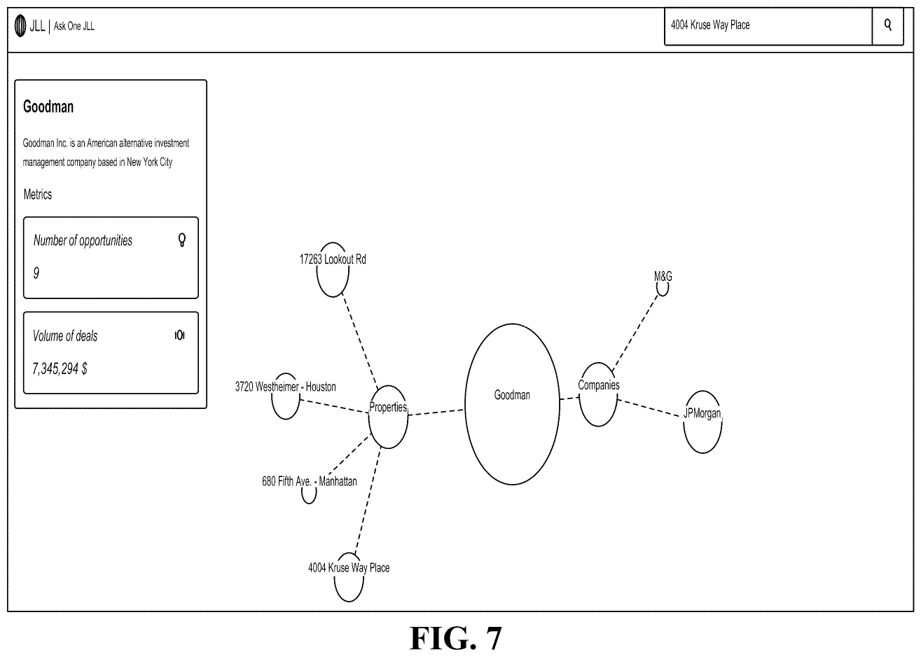

In step 320, the relational computing system 12 can also generate in a computer displayable format or other format an interactive map using the at least one node and the at least one edge. The interactive map can be a map of relationships between the entities. In a non-limiting example, the entities can be properties, companies, and stakeholders as illustrated in FIGS. 5 and 7. The entities can be represented in the interactive map as nodes, with the relationships between them depicted as edges. FIGS. 5 and 7 illustrate exemplary interactive maps.

The relational computing system 12 can use a JavaScript library for graph visualization (i.e., the interactive map), such as D3.js or Cytoscape.js, to create the interactive map with the at least one node and the at least one edge. Technically, the relational computing system 12 can achieve this by first converting the graph data structure into a format compatible with the chosen Javascript library. This involves creating JSON objects that represent the nodes and edges, including their attributes and relationships. This process includes initializing the graph visualization, setting up the layout algorithms (e.g., force-directed layout), and defining the visual properties of the nodes and edges (e.g., color, size, labels). The relational computing system 12 can then use the JavaScript library to render the interactive map on a web page or generate a graphical user interface (GUI) including the interactive map. The relational computing system 12 can then provide the web page or the GUI to a client device at one of the client devices 16(1)-(n). The JavaScript library can also provide interactive features, such as zooming, panning, and clicking on nodes to reveal additional information.

To enhance the interactive map, the relational computing system 12 can utilize Graph Neural Networks (GNNs), which are specifically built to be trained with graph data and fit seamlessly with the data model. GNNs are a class of machine learning algorithms designed to operate on graph structures, capturing the dependencies between nodes and edges. The main advantage of using GNNs over classical algorithms is the reduction in time and memory complexity, especially when the graph database contains a vast number of nodes and edges. The ability of the GNNs to perform inductive learning allows the relational computing system 12 to generalize to unseen nodes, enabling the relational computing system 12 to handle new properties or stakeholders added to the relational computing system 12 without the need to retrain the entire model 30. Additionally, GNNs offer scalability through techniques like graph sampling and batching, which can be applied to manage large-scale data efficiently.

The interactive map provides a comprehensive view of the business landscape, enabling users to identify hidden data, generate insights, and make data-driven decisions. Other advantages of the interactive map include the ability to visualize complex relationships in an intuitive manner, enhance collaboration among team members by providing a shared visual tool, and quickly identify key entities and their connections. The relational computing system 12 can also assist with search capabilities and the generation of insight data using the interactive map or the nodes and edges from the interactive map.

### Search Capabilities

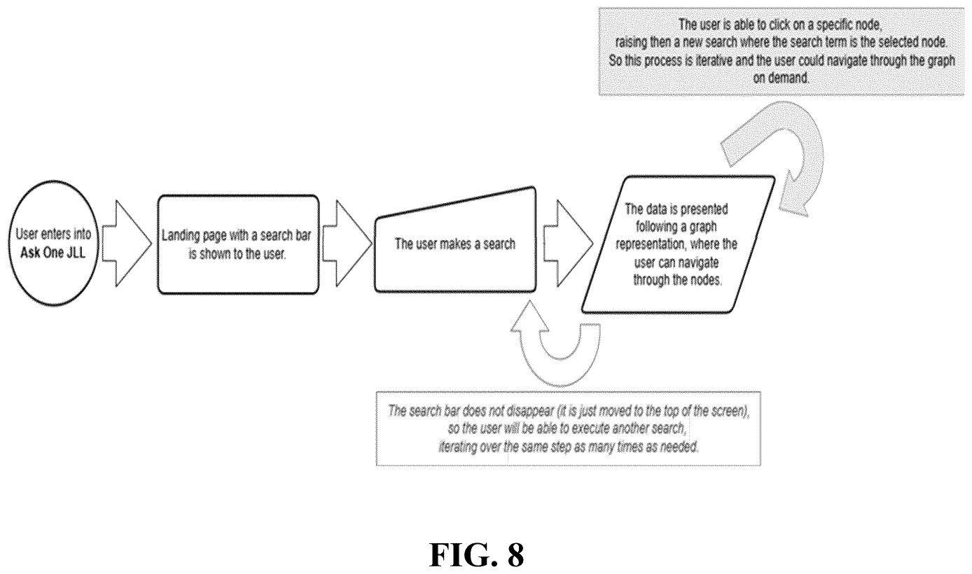

As further illustrated in FIG. 8, in a non-limiting example, the relational computing system 12 can receive an authentication request from a client device at one of the client devices 16(1)-(n), and process the authentication request to grant access to an application that includes the interactive map. The detailed steps for the authentication process can include a user at the client device at one of the client devices 16(1)-(n) initiating the authentication by opening the application and entering credentials. The relational computing system 12 can securely transmit the credentials to the authentication server using encryption protocols such as TLS. The authentication server can verify the credentials against a stored user database at one of the databases 14(1)-(n). If multi-factor authentication (MFA) is enabled, the server at one of the plurality of servers 18(1)-(n) can send a verification code to the user's registered device, which the user must enter into the application. Upon successful verification, the authentication server can generate an access token and send it back to the client device at one of the client devices 16(1)-(n). The client device at one of the client devices 16(1)-(n) can use the access token to establish a secure session with the application server via the relational computing system 12, granting the user access to the application.

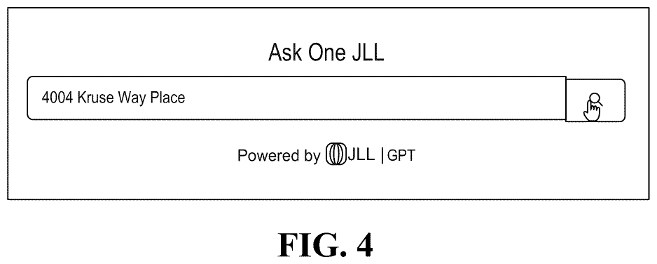

In step 325, the relational computing system 12 can receive, via an input bar (i.e., search bar as illustrated in FIGS. 4, 5, and 7), an input query related to the real estate data. The user can provide the input query in natural language. To translate the input query into machine language, the relational computing system 12 can use the Large Language Model (LLM) 30. The process can involve the user entering a natural language query, which the relational computing system 12 can transmit to the LLM 30 for processing. The LLM 30 can use Natural Language Processing (NLP) techniques to parse the query, identifying key entities, intents, and relationships within the text. The LLM 30 can leverage its training on vast datasets to understand the context of the query, recognizing specific terms related to real estate. The LLM 30 can then translate the natural language query into a structured machine language query, such as SQL or a graph query language. The benefit of using the LLM 30 can be to receive, in natural language, the context of what the user is seeing on the screen, such as an overview of a particular property or an explanation of an underlying connections between clients and their properties.

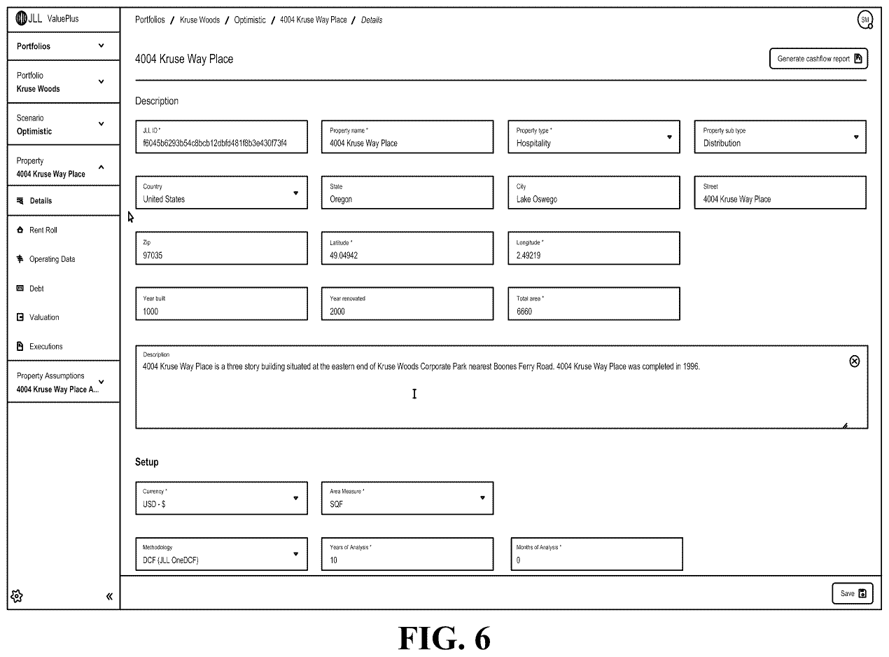

Apart from the input query, the user can select a node in the interactive map. The relational computing system 12 can receive the selected node and provide the user with a modified graphical user interface (GUI) displaying information related to the selected node as illustrated in FIG. 6. After making a selection, the user can navigate back to the graph (i.e., the interactive map) on demand and iteratively start over the input query or node selection process of steps 325 through 335. The input query process can be repeated at any time because the input bar can be moved to a different part of the interface as the user navigates the interactive map, such as the top of the screen, to allow for additional input queries as illustrated in FIGS. 5 and 7. After the selection of a node, if the user navigates back to the interactive map a new node can be selected and the process can repeat steps 325 through 335, allowing the user to continuously explore and interact with the real estate data in a dynamic and intuitive manner.

In step 330, the relational computing system 12 can retrieve relevant data from the interactive map or the nodes and edges database at ones of the databases 14(1)-(n) based on the translated input query or the selected node. The relational computing system 12 can identify the relevant data by analyzing the input query or the selected node to determine the associated entities and relationships. This process involves querying the graph database or other suitable data stores to locate relevant nodes and edges that match the criteria specified in the input query or that are connected to the selected node.

The relevant data can include at least one relevant node or at least one relevant edge. In a non-limiting example, if the input query pertains to a specific property, the relational computing system 12 can retrieve nodes representing that property, its stakeholders, and related transactions. Similarly, if a node representing a company is selected, the relational computing system 12 can retrieve edges that depict the company's relationships with various properties and stakeholders.

The relational computing system 12 can then provide the interactive map, including the relevant nodes and at least one relevant edge, to the user at one of the client devices 16(1)-(n). This updated interactive map allows the user to visualize the connections and relationships pertinent to their query or selection. The user can navigate and interact with the relevant nodes and edges, exploring the data in greater detail. This interactive capability enables users to gain deeper insights, identify potential business opportunities, and make informed decisions based on the visualized relationships and data connections.

Furthermore, due to the integration of a GNN with the interactive map, the relational computing system 12 can support faster search capabilities by leveraging inherent structure of graphs. GNNs can effectively capture dependencies between nodes, which is crucial for enhancing search capabilities as well. Graph Attention Networks could be implemented to focus on the most relevant connections (or nodes and edges) between data points, improving the accuracy and relevance of search results. Finally, GNNs can use message passing to aggregate information from neighboring nodes. This concept can be applied to gather and combine relevant data from connected platforms and entities.

### Recommendation System

In step 335, the relational computing system 12 can then generate, using a machine learning model 30, insight data based on the relevant data or on the relationships between the at least one relevant node and the at least one relevant edge. The insight data can include predictions of potential connections (i.e., potential nodes or potential edges) or business opportunities between the at least one relevant node and the at least one relevant edge.

In step 335, the relational computing system 12 can then generate, using a machine learning model 30, insight data based on the relevant data or on the relationships between the at least one relevant node and the at least one relevant edge identified in step 330. The insight data can include predictions of potential connections (i.e., potential nodes or potential edges) or business opportunities between the at least one relevant node and the at least one relevant edge. The relational computing system 12 can generate these predictions and identify business opportunities by analyzing the relationships between various data points through the identification of patterns and structures within the graph data. The system can make use of AI proprietary algorithms for several use cases: (1) providing an overview of the details of the property being displayed, including the context of the area or region beside its physical aspects; (2) providing a quick summary or explanation about the relationships shown in the graph, especially between clients and properties, where some of them could be sellers and others could be buyers, offering cross-selling opportunities for the brokers.

The relational computing system 12 can utilize various aggregation methods (sum, mean, or max) to combine information from different sources, providing a comprehensive view of the data. The benefit of using GNNs over traditional graph databases is to provide additional insights that would be very difficult to find manually, such as identifying similar properties bought by different clients or clients with similar behaviors when buying or selling real estate assets. GNNs can navigate complex knowledge graphs to provide users with precise answers and recommendations based on the input queries or selected nodes. This capability can help business users gain quick insights about relationships among clients for cross-selling opportunities or identify similar properties in different areas that can be part of new deal transactions.

For example, the machine learning model 30 can be configured to analyze historical transaction data and identify patterns that suggest a particular stakeholder is likely to invest in properties within a specific geographic area. By examining the relationships between the stakeholder node and property nodes, the relational computing system 12 can predict potential new investments or business opportunities. Similarly, the machine learning model 30 can identify potential connections between companies and properties based on shared attributes (such as industry type, transaction history, etc.). As a non-limited illustrative example, consider a scenario where the relational computing system 12 identifies a relevant node representing a property and another relevant node representing a stakeholder. The machine learning model 30 can analyze the historical data and relationships between similar properties and stakeholders to predict that this stakeholder is likely to be interested in acquiring the property. The relational computing system 12 can then generate insight data indicating this potential connection, providing the user with actionable intelligence to pursue the business opportunity.

By continuously analyzing the graph data and updating the predictions, the relational computing system 12 can help users stay informed about emerging trends and opportunities, ultimately enabling more informed decision-making and strategic planning. Then, in step 340, the process may terminate.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

1. A method for refining analysis implemented by a system comprising one or more apparatuses, client devices, or server devices, the method comprising:
storing real estate data from a plurality of platforms into a relational data structure;
generating at least one node and at least one edge using a ETL process and the relational data structure, wherein the ETL process uses data bricks and a data factory to transform the real estate data from the relational data structure into the at least one node and the at least one edge; and
providing in a computer displayable format an interactive map comprising a visualization of relationships between the at least one node and the at least one edge, wherein the interactive map is enhanced using a graph neural network configured to perform inductive learning to accommodate one or more new nodes added to the relational data structure.

2. The method as set forth in claim 1, wherein the relational data structure is an instance of Azure Cosmos DB.

3. The method as set forth in claim 1, wherein the real estate data comprises at least one of properties, companies, stakeholders, relationships, or combinations thereof.

4. The method as set forth in claim 1, wherein the generating the at least one node and the at least one edge using the ETL process and the relational data structure further comprise:
extracting the real estate data from the relational data structure using the data factory and a data lake storage;
transforming, using the data bricks, the extracted real estate data into the at least one node and the at least one edge; and
loading the at least one node and the at least one edge into a database.

5. The method as set forth in claim 4, wherein the extracting the real estate data from the relational data structure using the data factory and the data lake storage further comprise:
generating a connection between the relational data structure and the data lake storage; and
defining datasets in the data factory for the relational data structure and the data lake storage.

6. The method as set forth in claim 4, wherein the transforming the extracted real estate data into the at least one node and the at least one edge further comprises:
generating the at least one node by loading the real estate data into separate data frames for entities of the real estate data, wherein the entities of the real estate data comprise least one of properties, stakeholders, companies, or combinations thereof; and
defining edges by identifying relationships between entities of the real estate data.

7. The method as set forth in claim 1, further comprising:
receiving, via a computing apparatus, an input query related to the real estate data, wherein the input query is in a natural language;
translating, using a large language model, the input query into machine language; and
retrieving relevant data for the interactive map based on the translated input query.

8. The method as set forth in claim 1, further comprising:
generating, using a machine learning model, insight data based on the relationships between the at least one node and the at least one edge.

9. The method as set forth in claim 8, wherein the insight data comprises predictions of potential connections or business opportunities between the at least one node and the at least one edge.

10. A non-transitory computer readable medium having stored thereon instructions for refining analysis comprising executable code which when executed by one or more processors, causes the processors to:
store real estate data from a plurality of platforms into a relational data structure;
generate at least one node and at least one edge using a ETL process and the relational data structure, wherein the ETL process uses data bricks and a data factory to transform the real estate data from the relational data structure into the at least one node and the at least one edge; and
provide in a computer displayable format an interactive map comprising a visualization of relationships between the at least one node and the at least one edge, wherein the interactive map is enhanced using a graph neural network configured to perform inductive learning to accommodate one or more new nodes added to the relational data structure.

11. The non-transitory computer readable medium as set forth in claim 10, wherein the generating the at least one node and the at least one edge using the ETL process and the relational data structure further comprise:
extracting the real estate data from the relational data structure using the data factory and a data lake storage;
transforming, using the data bricks, the extracted real estate data into the at least one node and the at least one edge; and
loading the at least one node and the at least one edge into a database.

12. The non-transitory computer readable medium as set forth in claim 11, wherein the transforming the extracted real estate data into the at least one node and the at least one edge further comprises:
generating the at least one node by loading the real estate data into separate data frames for entities of the real estate data, wherein the entities of the real estate data comprise least one of properties, stakeholders, companies, or combinations thereof, and
defining edges by identifying relationships between entities of the real estate data.

13. The non-transitory computer readable medium as set forth in claim 10, wherein the executable code when executed by the one or more processors, further cause the one or more processors to:
receive, via a computing apparatus, an input query related to the real estate data, wherein the input query is in a natural language;
translate, using a large language model, the input query into machine language; and
retrieve relevant data for the interactive map based on the translated input query.

14. The non-transitory computer readable medium as set forth in claim 10, wherein the executable code when executed by the one or more processors, further cause the one or more processors to:
generate, using a machine learning model, insight data based on the relationships between the at least one node and the at least one edge, wherein the insight data comprises predictions of potential connections or business opportunities between the at least one node and the at least one edge.

15. An apparatus, comprising memory comprising programmed instructions stored in the memory and one or more processors configured to be capable of executing the programmed instructions stored in the memory to:
store real estate data from a plurality of platforms into a relational data structure;
generate at least one node and at least one edge using a ETL process and the relational data structure, wherein the ETL process uses data bricks and a data factory to transform the real estate data from the relational data structure into the at least one node and the at least one edge; and
provide in a computer displayable format an interactive map comprising a visualization of relationships between the at least one node and the at least one edge, wherein the interactive map is enhanced using a graph neural network configured to perform inductive learning to accommodate one or more new nodes added to the relational data structure.

16. The apparatus as set forth in claim 15, wherein the relational data structure is an instance of Azure Cosmos DB and wherein the real estate data comprises at least one of properties, companies, stakeholders, relationships, or combinations thereof.

17. The apparatus as set forth in claim 15, wherein the generating the at least one node and the at least one edge using the ETL process and the relational data structure further comprise:
extracting the real estate data from the relational data structure using the data factory and a data lake storage;
transforming, using the data bricks, the extracted real estate data into the at least one node and the at least one edge; and
loading the at least one node and the at least one edge into a database.

18. The apparatus as set forth in claim 15, wherein the programmed instructions when executed by the one or more processors, further cause the one or more processors to:
generating a connection between the relational data structure and a data lake storage;
defining datasets in the data factory for the relational data structure and the data lake storage;
generating the at least one node by loading the real estate data into separate data frames for entities of the real estate data, wherein the entities of the real estate data comprise least one of properties, stakeholders, companies, or combinations thereof; and
defining edges by identifying relationships between entities of the real estate data.

19. The apparatus as set forth in claim 15, wherein the programmed instructions when executed by the one or more processors, further cause the one or more processors to:
receive, via a computing apparatus, an input query related to the real estate data, wherein the input query is in a natural language;
translate, using a large language model, the input query into machine language; and
retrieve relevant data for the interactive map based on the translated input query.

20. The apparatus as set forth in claim 15, wherein the programmed instructions when executed by the one or more processors, further cause the one or more processors to:
generate, using a machine learning model, insight data based on the relationships between the at least one node and the at least one edge, wherein the insight data comprises predictions of potential connections or business opportunities between the at least one node and the at least one edge.
